(19) United States
(12) Patent Application Publication
(10) Pub. No.: US 2003/0065702 A1
(43) Pub. Date: Apr. 3, 2003

(54) Cache conscious load balancing

(76) Inventors: Ravinder Singh, Folsom, CA (US); Hsien-Cheng Hsieh, Gold River, CA (US); Candice Huang, Gold River, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/962,964

(22) Filed: Sep. 24, 2001

(51) Int. Cl. G06F 9/00

(52) U.S. Cl. 709/105

(57) ABSTRACT

In a multiprocessor application server, multiple transaction types are determined. Performance statistics for each of the multiple transaction types are determined. The multiple transaction types are mapped to two or more processing units using the performance statistics to form a dispatch table. Incoming transactions are dispatched to the two or more processing units using the dispatch table.

### FIELD OF THE INVENTION

The present invention relates generally to field of load balancing. More specifically, the present invention relates to a method and an apparatus for load balancing to effectively use processor cache.

### BACKGROUND

Load balancing is a technique that divides an amount of work among multiple processing units so that no one single processing unit is overwhelmed. With load balancing, more work gets done in the same amount of time, and in general all users get served faster.

In the World Wide Web (WWW), load balancing is especially important because it is difficult to predict the number and order/sequence of requests that will be issued to a server. While small web sites can be served from a single server, busy web sites typically employ two or more web servers in a load-balancing scheme. FIGS. 1A and 1B are diagrams illustrating prior art load-balancing schemes using a server cluster. In this example, a server cluster includes web servers 120, 125, and 130. Typically, these web servers 120,125 and 130 are cloned servers 145 each having a mirror copy of all available resources. Each of the web servers 120, 125, and 130 may contain thousands of individual web pages and is capable of serving any request 135 from the browser 105. There may be multiple browsers similar to the browser 105 sending requests 135 to access resources on the web site through the network 110. Typically, a dispatcher 115 receives the requests 135 from the browser 105. The dispatcher 115 may be a software residing on a dedicated computer or it may be a hardware component. The dispatcher 115 selects one of the web servers 120, 125, and 130 based on a load-balancing algorithm to forward the request to. If one web server starts to get swamped, the requests 135 are forwarded to another web server having more available capacity. The selected web server then sends the requested resource back to the browser 105. The dispatcher 115 dispatches the requests 135 according to a server cluster level load balancing algorithm 140.

FIGS. 2A and 2B are diagrams illustrating a prior art load-balancing schemes used by a runtime environment/operating system. Each of the web servers 120, 125, and 130 illustrated in FIG. 1A may be associated with an underlying runtime environment/operating system 200. The runtime environment/operating system 200 may be running on a multiprocessor server having processors 215, 220 and 225. The requests sent to the runtime environment/operating system 200 may be in the form of Java threads or OS threads 205 for example. The Java threads/OS threads 225 are dispatched to processors (CPUs) 215, 220, and 225 (or generally processors 240) according to a runtime environment's load balancing algorithm 235.

The web/application servers are typically computer systems with fast processors and large cache memory. For example, the Intel Pentium III Xeon processor (P3XP) has 2 megabytes (MB) of level two (L2) cache. When the incoming transactions are of different types and arrive in a random order, the cache memory is often not utilized effectively.

### BRIEF DESCRIPTION OF THE DRAWINGS

The present invention is illustrated by way of example, and not limitation, in the figures of the accompanying drawings in which like references indicate similar elements and in which:

FIGS. 1A and 1B are diagrams illustrating prior art load-balancing techniques used in a server cluster.

FIGS. 2A and 2B are diagrams illustrating a prior art load-balancing techniques used by a runtime environment/operating system.

FIGS. 3A and 3B are block diagrams illustrating one embodiment of a cache-conscious load balancing technique which uses knowledge of a particular request to decide which processor to schedule a transaction on.

FIG. 4 is a flow diagram illustrating a load balancing process in accordance with one embodiment of the present invention.

FIG. 5 is a flow diagram illustrating one embodiment of a transaction type-to-processing unit mapping process.

FIG. 6 is an illustration of one embodiment of a digital processing system that can be used with the present invention.

### DETAILED DESCRIPTION

A method and a system for load balancing are disclosed. In an application server, possible transaction types and performance statistics of the transaction types are considered to map the transaction types to multiple processing units. Dependent transaction types are mapped to same processing unit. A dispatch table is formed based on the mapping information. The dispatch table is used to dispatch incoming transactions.

In the following description, “latency time” refers to an average time taken by a processor to process a transaction of a particular transaction type. A “transaction type mixture information” refers to a frequency of how often a particular transaction type arrives at the application server among all of the possible transaction types. A “processing latency time” refers to a time it takes for a processor to process a group of a particular transaction type. A “processing unit” is one of multiple processors that an incoming transaction is dispatched to. A “total processing latency time” is an accumulation of “processing latency time” of the transaction types that have been mapped to a processing unit.

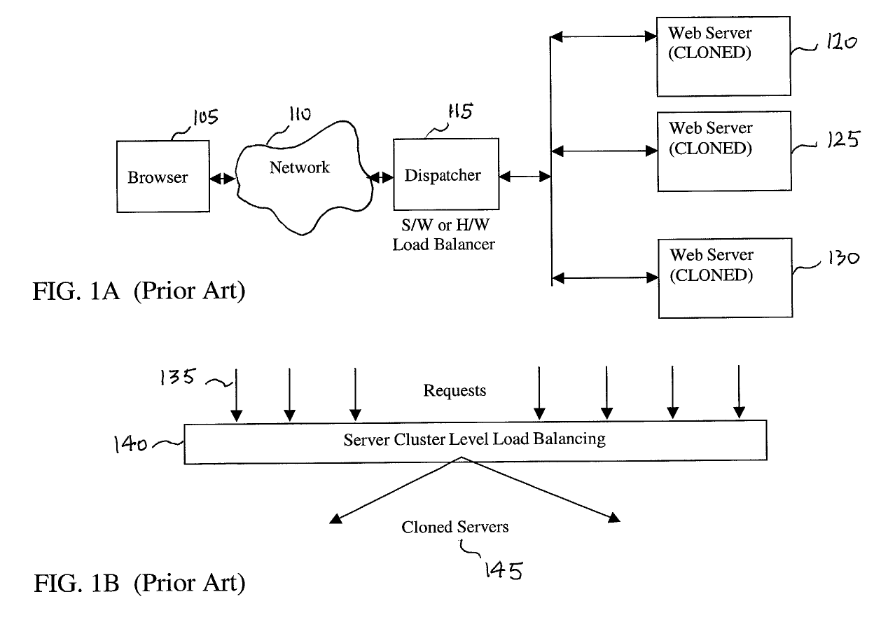

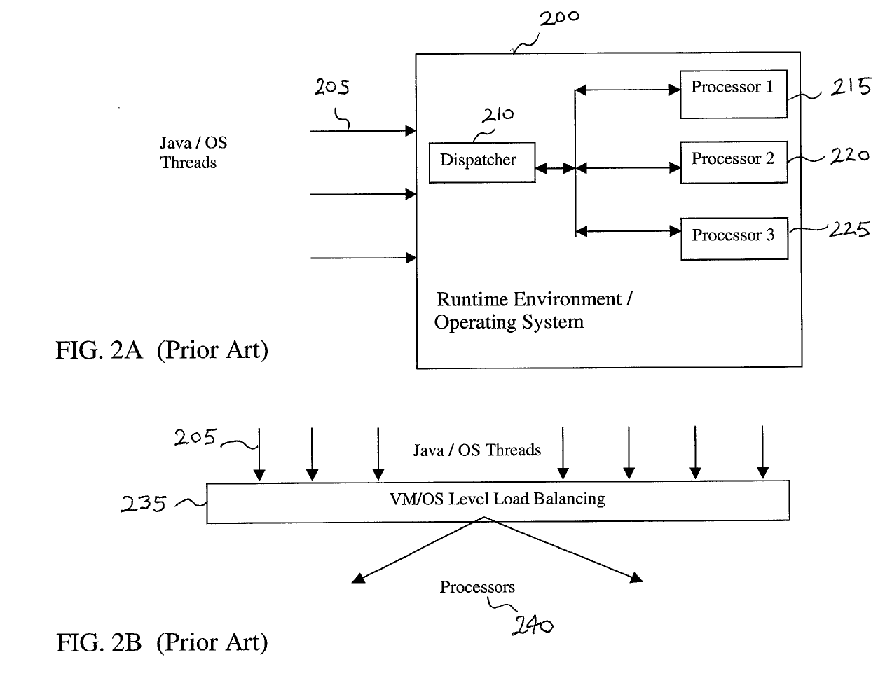

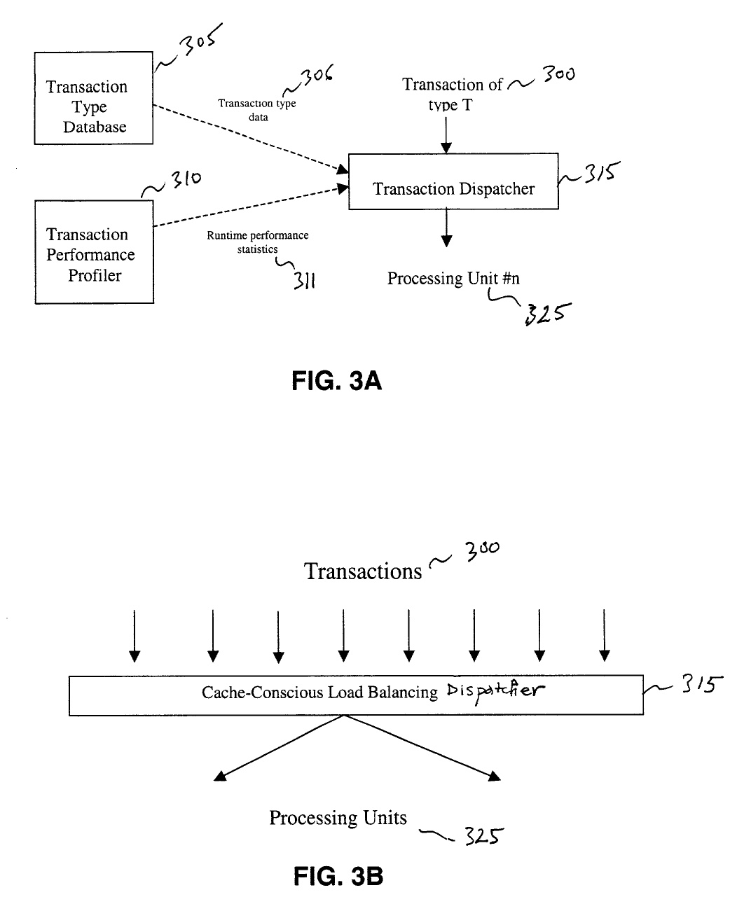

FIGS. 3A and 3B are block diagrams illustrating one embodiment of a cache-conscious load balancing technique which uses knowledge of the particular request to decide which processor to schedule the transaction on. The technique may be viewed as being in between the techniques described in FIGS. 1A and 1B, and FIGS. 2A and 2B. Transaction type database (TTD) 305 includes information about the possible transaction types. For example, for a stock brokerage application, the possible transaction types may include: “buy”, “sell”, “account”, “update”, “quote”, “home”, “portfolio”, “register”, etc. The TTD 305 also include transaction type mixture information (i.e., information about how frequent certain transaction types typically occur). The following table is an illustration of a break down of transaction type mixture information in a sample of one hundred transactions received in the brokerage application.

| Transaction Types | Mixture |
|---|---|
| buy | 5% |
| sell | 5% |
| account | 15% |
| update | 8% |
| quote | 40% |
| home | 5% |
| portfolio | 8% |
| register | 2% |

Depending on the complexity of the transaction, the latency time may be different for each transaction type. For example, a “quote” transaction type does not have very much latency time because it generally involves reading data. In contrast, a “buy” or a “sell” transaction type has much longer latency time because an account database has to be updated. In one embodiment, the latency time and the transaction type frequency information for each transaction type are used to determine processing latency time for each group of transaction type using the following formula:

Processing latency time for a group of transaction type T=(Number of T's in the mixture)×(Latency time of each T).

For example, when the latency time of the “buy” transaction is 20 milliseconds, and the number of the “buy” transaction in the mix is five (5) percent, the processing latency time for group of the “buy” transaction is: 5×20=100 milliseconds. Similarly, when the latency time of the “quote” transaction is 5 milliseconds, and the number of the “quote” transaction in the mix is forty (40) percent, the processing latency time for the group of “quote” transaction is: 40×5=200 milliseconds.

The processing latency time for each transaction type group is stored in the transaction performance profiler 310 (TPP). In general, the TPP 310 is responsible for collecting transaction performance related statistics. For example, the TPP 310 may include transaction types, latency time for each transaction type, processing unit utilization, processing unit cache miss rate, etc.

Some of the transaction types can be dependent on one another. For example, the “sell” transaction type can be dependent on the “buy” transaction type. Similarly, the “account” transaction type is dependent on the “portfolio” transaction type, etc. The “quote” transaction is independent or not dependent on any other transaction. In one embodiment, transaction types that are dependent on one another are grouped together. Transaction type grouping information may be stored in the TTD 305. There may be different ways to implement the TTD 305 such as, for example, as a set of user-visible APIs that programmers use to specify the transaction types.

In general, the TTD 305 is user or programmer defined and includes, for example, dependent groups information and typical mix in real life. The TTP 310 is responsible for calculating runtime statistics information such as, for example, latency time of each transaction type, CPU utilization, cache misses, etc.

The TTD 305 and the TPP 310 are used to map the transaction types to the processing units and to form a dispatch table (not shown). A transaction scheduler (or cache-conscious load balancing scheduler) 315 uses the dispatch table to dispatch an incoming transaction 300 to an appropriate processing unit 325.

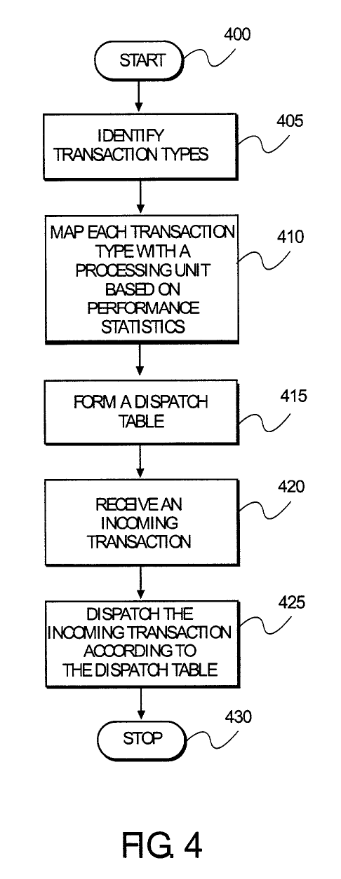

FIG. 4 is a flow diagram illustrating a load balancing process in accordance with one embodiment of the present invention. The process starts at block 400. At block 405, the different possible transaction types are identified. These are the transaction types that an application server may encounter. At block 410, each of the transaction types is mapped to a processing unit. As described above, a transaction is mapped to a processing unit based on whether it is a dependent transaction and based on the processing latency time.

At block 415, a dispatch table is formed using the mapping information generated in block 410. The dispatch table allows the scheduler to quickly dispatch an incoming transaction of a particular transaction type to a processor that the transaction type is mapped to, as shown in block 420 and 425. The incoming transaction is dispatched to the processor as soon as it arrives. The process stops at block 430.

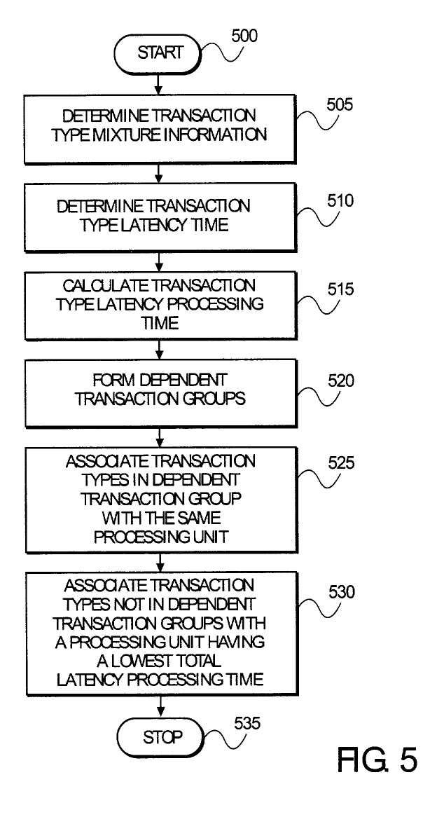

FIG. 5 is a flow diagram illustrating one embodiment of a transaction type-to-processing unit mapping process. The flow diagram corresponds to the operation performed in block 410 in FIG. 4. The process starts block 500. At block 505, transaction type mixture information is determined. The transaction type mixture information may be entered by a user based on various samples of transactions received by the application server in a real life scenario. At block 510, transaction type latency time is determined. This may be approximated by averaging multiple latency times of the transaction type. At block 515, the transaction type processing latency time is calculated. As described above, this is done by multiplying the transaction type mixture information with the transaction type latency time.

At block 520, dependent transaction groups are formed. For example, using the brokerage transaction types described above, the following two dependent transaction groups are formed:

| Dependent Group Number | Transaction Types |
|---|---|
| 1 | “buy”, “sell” |
| 2 | “account”, “portfolio” |

The remaining transaction types (e.g., “quote”) in the brokerage example are considered independent transaction types.

At block 525, each transaction type is mapped to a processing unit. In one embodiment, mapping of the transaction type begin with the transaction types in the dependent groups such that the dependent transaction types in each group are mapped to the same processing unit. For example, the “buy” and “sell” transaction types are mapped to the same processing unit. Similarly, the “account” and the “portfolio” transaction types are mapped to the same processing unit. When there are two or more processing units, the transaction types in each dependent group are mapped to a different processing unit. For example, the “buy” and “sell” transaction types are mapped to a first processing unit, and the “account” and the “portfolio” transaction types are mapped to a second processing unit. When there are more dependent groups than the number of processing units, the transaction types in more than one dependent group may be mapped to the same processing unit. When a dependent transaction type is mapped to a processing unit, the total processing latency time of the processing unit is incremented using the processing latency time of that dependent transaction type.

When all of the transaction types in the dependent transaction groups have been mapped, the independent transaction types are mapped to the processing units. In one embodiment, each independent transaction type is mapped to a processing unit having a lowest total processing latency time, as shown in block 530. As described above, when the independent transaction type is mapped to the processing unit, the total processing latency time of the processing unit is incremented using the processing latency time of that independent transaction type. The operation in block 530 continues until all of the independent transaction types have been mapped. The process stops at block 535.

Referring to FIG. 4, the block 425 indicates a dispatch operation where the incoming transactions are dispatched to the processing units according to the dispatch table. In one embodiment, the incoming transactions are dispatched to dispatcher buffers (DB) associated with the intended processing units. When the number of transactions in a DB reaches a certain threshold, the transactions in the DB are dispatched to the associated processing unit

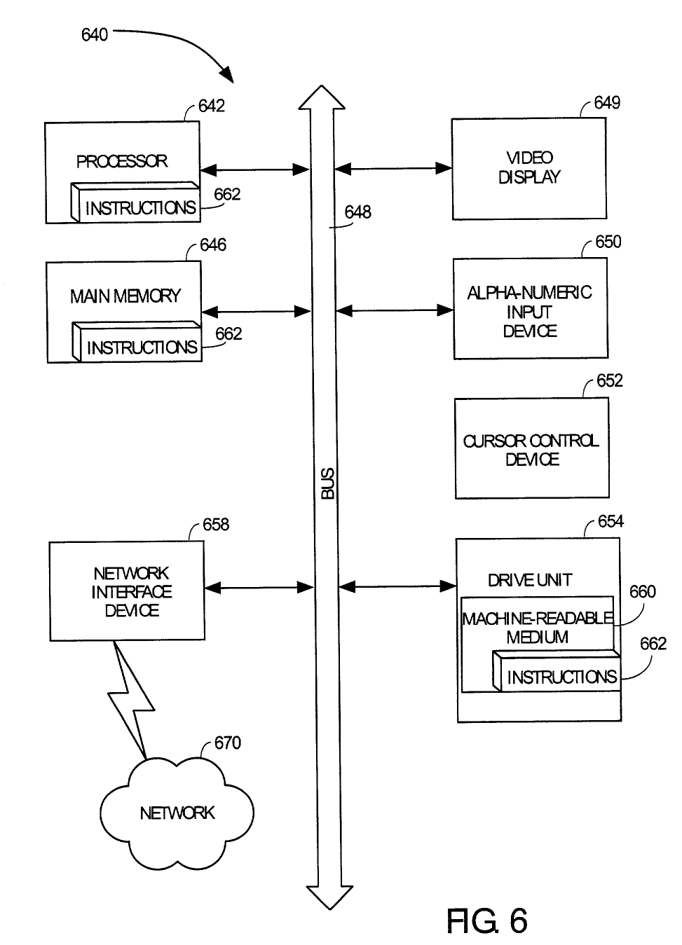

FIG. 6 is an illustration of one embodiment of a digital processing system that can be used with the present invention. The operations of the various methods of the present invention may be implemented by a processor 642 in a digital processing system 640. The digital processing system 640 may be an application server. The processor 642 executes sequences of computer program instructions 662 to implement the load balancing technique described above. For example, the computer program instructions 662 may include instructions to calculate processing latency time of each transaction type, instructions to map the different transaction types to multiple processing units (not shown), instructions to form the dispatch table, and instructions to dispatch the incoming transactions.

The instructions 662 may be stored in a memory which may be considered to be a machine readable storage media 660. The machine-readable storage media 660 may be used with a drive unit 654 coupled with the bus 648. The memory may be random access memory (RAM) 646. Although not shown, the memory may also be read-only memory (ROM), a persistent storage device or any combination of these devices. Execution of the sequences of instruction 662 causes the processor 642 to perform operations according to the present invention. The instructions 662 may be loaded into memory of the computer from a storage device or from one or more other digital processing systems (e.g. a server computer system) over a network connection. The instructions 662 may be stored concurrently in several storage devices (e.g. DRAM and a hard disk, such as virtual memory). Consequently, the execution of these instructions may be performed directly by the processor 642. The digital system 640 may include a network interface device 658 to receive incoming transactions through network 670. Other devices coupled with the bus 648 in the digital processing system 640 may include a video display 649, an alpha-numeric input device 650, a cursor control device 652, etc.

In other cases, the instructions 662 may not be performed directly or they may not be directly executable by the processor 642. Under these circumstances, the executions may be executed by causing the processor 642 to execute an interpreter that interprets the instructions 662, or by causing the processor 642 to execute instructions which convert the received instructions 662 to instructions which can be directly executed by the processor 642. In other embodiments, hard-wired circuitry may be used in place of or in combination with software instructions to implement the present invention. Thus, the present invention is not limited to any specific combination of hardware circuitry and software, nor to any particular source for the instructions executed by the digital processing system 640.

Although the load balancing technique described above refers to a multiprocessors application server, the dispatching of transactions based on transaction types and transaction performance statistics may also be applied to other applications where load balancing is desired.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method, comprising:
identifying multiple transaction types to be processed by a load balancing system having two or more processing units;
determining performance statistics for each of the multiple transaction types;
mapping each of the multiple transaction types to the two or more processing units using the performance statistics to form a dispatch table; and
dispatching incoming transactions to the two or more processing units using the dispatch table.

2. The method of claim 1, wherein determining the performance statistics of each of the multiple transaction types comprises:
identifying transaction mixture information for each transaction type among the multiple transaction types;
determining latency time for each transaction type in the multiple transaction types; and
calculating processing latency time for each transaction type using the transaction mixture information and the latency time.

3. The method of claim 1, further comprising forming dependent transaction groups from the multiple transaction types.

4. The method of claim 3, wherein forming dependent transaction groups comprises forming one dependent transaction group for each group of dependent transactions.

5. The method of claim 4, wherein mapping each of the multiple transaction types to two or more processing units to form the dispatch table comprises:
mapping transaction types in a first dependent transaction group to a first processing unit;
updating a total processing latency time associated with the first processing unit using the processing latency time of the transaction types in the first dependent transaction group; and
repeating said mapping and said updating using a next dependent transaction group and a next processing unit until all of the transaction types in the dependent transaction groups are mapped.

6. The method of claim 5, further comprises:
after mapping all of the transaction types in the dependent transaction groups, selecting a processing unit having a lowest total processing latency time;
mapping an independent transaction type to the selected processing unit;
updating the total processing latency time associated with the selected processing unit using the processing latency time of the independent transaction type; and
repeating said selecting, mapping and updating until all of the independent transaction types are mapped.

7. The method of claim 1, wherein dispatching the incoming transactions to the processing units comprises:
for each processing unit, dispatching the incoming transaction to a dispatch buffer associated with the processing unit; and
dispatching the incoming transactions from the dispatch buffer to the processing unit when the dispatch buffer reaches a predetermined threshold.

8. A computer readable medium having stored thereon sequences of instructions which are executable by a system, and which, when executed by the system, cause the system to:
identify multiple transaction types to be processed by a load balancing system having two or more processing units;
determine performance statistics for each of the multiple transaction types;
map each of the multiple transaction types to the two or more processing units using the performance statistics to form a dispatch table; and
dispatch incoming transactions to the two or more processing units using the dispatch table.

9. The computer readable medium of claim 8, wherein the instructions to determine the performance statistics of each of the multiple transaction types comprises instructions to:
identify transaction mixture information for each transaction type among the multiple transaction types;
determine latency time for each transaction type in the multiple transaction types; and
calculate processing latency time for each transaction type using the transaction mixture information and the latency time.

10. The computer readable medium of claim 8, further comprising instructions to form dependent transaction groups from the multiple transaction types.

11. The computer readable medium of claim 10, wherein the instructions to form the dependent transaction groups comprises instructions to form one dependent transaction group for each group of dependent transactions.

12. The computer readable medium of claim 11, wherein the instructions to map each of the multiple transaction types to two or more processing units to form the dispatch table comprises instructions to:
map transaction types in a first dependent transaction group to a first processing unit;
update a total processing latency time associated with the first processing unit using the processing latency time of the transaction types in the first dependent transaction group; and
repeat said instructions to map and to update using a next dependent transaction group and a next processing unit until all of the transaction types in the dependent transaction groups are mapped.

13. The computer readable medium of claim 12, further comprises instructions to:
after all of the transaction types in the dependent transaction groups are mapped, select a processing unit having a lowest total processing latency time;
map an independent transaction type to the selected processing unit;
update the total processing latency time associated with the selected processing unit using the processing latency time of the independent transaction type; and
repeat said instructions to select, to map and to update until all of the independent transaction types are mapped.

14. The computer readable medium of claim 8, wherein the instructions to dispatch the incoming transactions to the processing units comprises instructions to:
for each processing unit, dispatch the incoming transaction to a dispatch buffer associated with the processing unit; and
dispatch the incoming transactions from the dispatch buffer to the processing unit when the dispatch buffer reaches a predetermined threshold.

15. A system, comprising:
a bus;
a memory coupled to the bus;
a processor coupled to the memory and the bus, wherein the processor forms a dispatch table by mapping each of multiple transaction types to two or more processing units based on processing latency time associated with each of the multiple transaction types, and dispatches incoming transactions of multiple transaction types to the two or more processing units using the dispatch table.

16. The system of claim 15, wherein the processing latency time associated with each of the multiple transaction types is determined based on latency time and transaction type mixture information for each transaction type among the multiple transaction types.

17. The system of claim 15, wherein the multiple transaction types comprise dependent transaction types and independent transaction types, and wherein the transaction types that are dependent on one another are mapped to a common processing unit.

18. The system of claim 17, wherein each of the independent transaction types is mapped to a processing unit having a lowest total processing latency time, wherein the total processing latency time for the processing unit is updated with the processing latency time of the dependent or independent transaction type mapped to that processing unit.

19. The system of claim 15, wherein each of the incoming transactions is dispatched to a dispatch buffer associated with a processing unit prior to dispatching to that processing unit.

20. The system of claim 19, wherein the incoming transactions in the dispatch buffer are dispatched to the associated processing unit when a buffer threshold is reached.

21. A system, comprising:
means mapping multiple transaction types to two or more processing units to form a dispatch table; and
means for dispatching incoming transactions to the two or more processing units using the dispatch table.

22. The system of claim 21, wherein the means for mapping comprises:
means for determining latency time for each transaction type; and
means for determining transaction mixture information for each transaction type among the multiple transaction types.

23. The system of claim 22, wherein the means for mapping further comprises means for determining independent and dependent transaction types such that dependent transaction types are mapped to a common processing unit.

24. The system of claim 23, further comprises means for mapping each of the independent transaction types to a processing unit having a lowest total processing latency time, wherein the total processing latency time for the processing unit is updated with the processing latency time of the dependent or independent transaction type mapped to that processing unit.

25. A method, comprising:
identifying transaction types for multiple incoming transactions to be processed;
computing processing latency time for each transaction type;
grouping dependent transaction types into dependent transaction groups;
mapping transaction types to two or more processing units until all of the transaction types are mapped to form a dispatch table; and
dispatching incoming transactions to the two or more processing units based on the dispatch table.

26. The method of claim 25, wherein computing the processing latency time for each transaction type comprises determining latency time and transaction type mixture information for each transaction type.

27. The method of claim 25, wherein mapping the transaction types to two or more processing units until all of the transaction types are mapped to form a dispatch table, comprises:
mapping dependent transaction types from each of the dependent transaction groups to a different processing unit;
mapping independent transaction types to a processing unit having a lowest total processing latency time; and
updating the total processing latency time for the processing unit using the processing latency time of the mapped dependent and independent transaction types.
